(19) United States
(12) Patent Application Publication
(10) Pub. No.: US 2012/0233200 A1
(43) Pub. Date: Sep. 13, 2012

(54) DATABASE DATA LOCALIZATION

(76) Inventors: Farahnaz Faegh, Encinitas, CA (US); Peter Budic, San Diego, CA (US)

(21) Appl. No.: 13/046,400

(22) Filed: Mar. 11, 2011

(51) Int. Cl. G06F 17/30

(52) U.S. Cl. 707/769; 707/803; 707/805; 707/E17.005; 707/E17.014

(57) ABSTRACT

A computer (100) is used to add fields (124) to a database (110). The computer is then used to specify (202), for each of the fields, a respective conversion tool (202) for converting a native vocabulary (114) for that field into a local vocabulary (116) for that field so that different fields can be associated with different conversion tools.

### BACKGROUND

Software users can be more comfortable and productive when the software is presented in a language familiar to the user. Software manufacturers can expand their markets by making localized versions of their software or otherwise providing for localization. Localization can involve providing for various nationally and culturally specific languages, as well as for discipline-specific versions, e.g., versions tailored for engineering, medical, legal, and other disciplines.

### BRIEF DESCRIPTION OF THE DRAWINGS

The following figures represent examples or implementations of the invention and not the invention itself.

FIG. 1 is a schematic diagram of a database management system.

FIG. 2 is a flow chart of a process implemented using the system of FIG. 1.

FIG. 3 is a combination of a schematic diagram and flow chart of another database management system and a process implemented using that system.

FIG. 4 is a schematic diagram of a database table and conversion tools of the system of FIG. 3.

FIG. 5 is a diagram of a database implementable in the system of FIG. 3.

### DETAILED DESCRIPTION

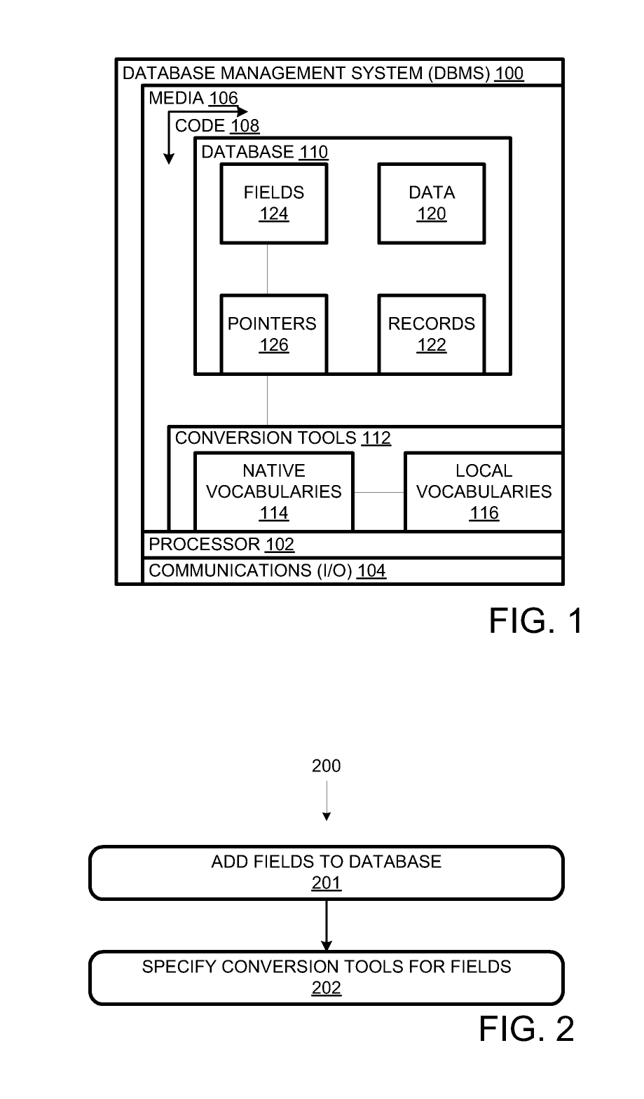

A database system 100, shown in FIG. 1, provides for field-specific localization for database data. Consider the problem of Chinese localization when a new product named, for example, “Kraz” is added to a product database. One cannot rely on standard translation tools, since “Kraz” is not in any dictionary; also, cultural differences must be taken into account when translating a “crazy”-sounding word that might carry different connotations in different countries.

In such a scenario, a database system could provide a conversion tool that converts the native (i.e., used within the database) vocabulary (list of acceptable values) for a product field into a local Chinese vocabulary. After “Kraz” is added to the native vocabulary, a culturally appropriate Chinese counterpart can be associated with Kraz in the conversion tool. A pointer to the conversion tool can be associated with the product field so that, when a user query returns “Kraz”, the Chinese counterpart is displayed instead of “Kraz”. If another field uses “Kraz” in the same way, its pointer can point to the same conversion tool. If another field uses “Kraz” in a different way, e.g., to refer to a web site related to the product, a different pointer for that field can point to a different conversion tool so that a different localization can be obtained. Thus, field-specific localization provides for convenient and flexible database data localization.

Database system 100 includes a computer with a processor 102, communications (including input/output) devices 104, and computer-readable storage media 106. Media 106 is encoded with code 108 defining a database 110 and conversion tools 112. Conversion tools 112 provide for converting native data (data expressed in a native vocabulary 114) into local data (data expressed in a localized vocabulary 116). Database 110 includes database data 120 expressed in native vocabularies 114 and arranged in records 122 and fields 124. In additional database 110 includes pointers 126 associating fields 124 with respective conversion tools 112.

Code 108 is configured to, when executed by processor 102, implement a process 200, flow-charted in FIG. 2. At 201, database system adds fields 124 to database 110. At 202, database system 102 associates these fields with conversion tools 112 for converting native vocabulary 114 in which database data 120 is expressed in database 110 into one or more local vocabularies 116 for presentation (e.g., display) to a user to provide for field-specific localization for presentation of database data 120.

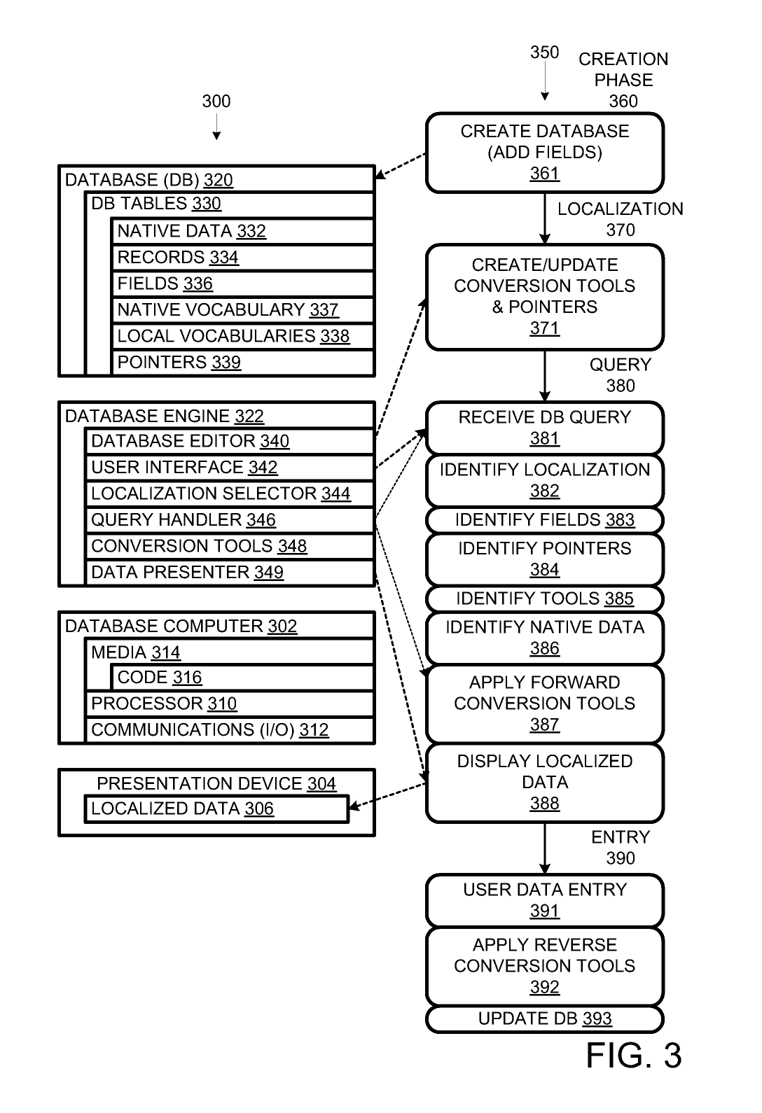

Further features are provided by database management system 300, shown in FIG. 3. Database management system 300 includes a computer 302 and a presentation device 304 (e.g., a display monitor or a printer) for presenting localized data 306. Database computer 302 has a processor 310, communications (input/output) devices 312, and computer-readable storage media 314. Media 314 is encoded with code 316 defining a database 320 and a database engine 322.

Database 320 includes one or more database tables 330. For example, a flat file database may include a single table, while a relational database can include plural interrelated tables. Database 320 includes “natively expressed” (aka “native”) database data 322; in this case, “native” refers to the language or vocabulary in which the data stored in a database is expressed; “locally-expressed” or “localized” database data is data expressed in a localized language or vocabulary. Herein, “native” and “local” are used to characterize alternative expressions of the same underlying data.

Database 320 can include records 334 and fields 336; for example, a database in the form of a spreadsheet can include records in the form of rows and fields in the form of columns. Native database data 332 is arranged in tables 330, records 334, and fields 336. Within a table, data is arranged in records and fields.

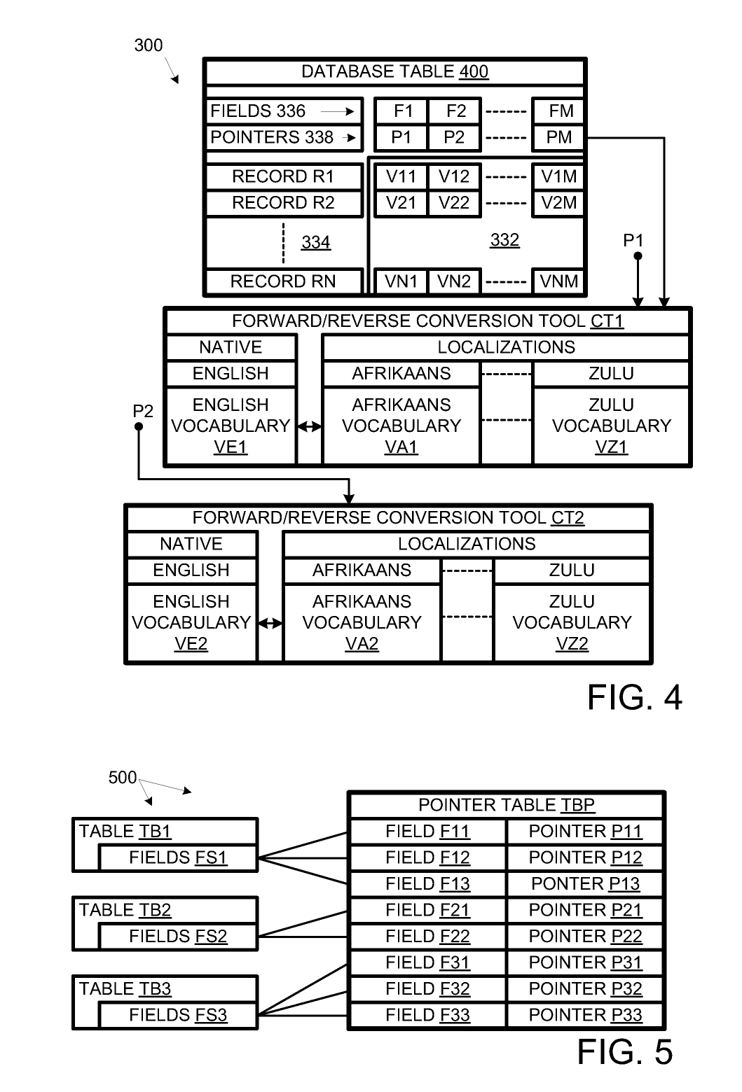

Database 320 further includes pointers 339 or at least pointer fields in which pointers can be entered. Each pointer specifies, for the associated field, a location of a conversion tool, as explained below. Pointers 339 can be located in a database table 330 along with other native database data. For example, as shown in FIG. 4, a spreadsheet can have a row dedicated to pointers, whereas other rows are used for records. Alternatively, as shown in FIG. 5, a database can include a separate table associating pointers with respective fields, which may be drawn from separate database tables.

Database engine 322 includes a database editor 340, a user interface 342, a localization selector 344, a query handler 346, conversion tools 348, and a data presenter 349. Database editor 340 is used to develop database 320, e.g., to define tables and fields. In addition, database editor 340 is used to create and modify localizations, e.g., by developing conversion tools 348 and by setting pointers 339.

User interface 342 is provided to enable a user to access, e.g., submit queries to, database 320; in some cases, a user may be able to add or update data in database 320 using user interface 342. User interface 342 provides access to localization selector 344, which a user can use to select a localization, e.g., from a drop-down list of alternatives. In one variant, a selected localization applies both to database program elements (e.g., menu items) and to the expression of database data. In another variant, localizations for program elements and data items can be selected independently so that one localization is applied to program elements and another localization is applied to data.

Query handler 346 accepts and handles user queries made using interface 342. A selected localization can be applied in interpreting user inputs, presenting program elements, and in presenting query results in the form of localized data. Query handler 346 can access conversion tools for use in converting native data to localized data for providing database data in localized form. Data presenter 349 presents query results in localized form, e.g., on presentation device 304.

Conversion tools 348 can take the form of translation tables or of a formula. For a field that accepts only “yes” and “no” as data values, a translation table can provide localization for “yes” and “no” in one or more localized languages or vocabularies. For a field that accepts a range of numeric values, a conversion formula or a set of different formulas for different localizations might serve as a conversion tool. In some cases, conversion tools that provide for different localization include an input for receiving a signal indicating a selected localization. If a user is permitted to add or update database data, bi-directional or reverse conversion tools (e.g., reverse translation tables) can be provided to convert a user's localized input data into native database data.

Code 316 defines the functionality of database engine 322 and its components and defines native database data 332, pointers 339, and data structures including tables 330, records 334, fields 336, a native vocabulary 337, and local vocabularies 338; for example, the vocabulary for a field can be a list or range of values that can be entered into the field. Code 316 is configured to, when executed by processor 310, implement a process 350. Process 350 includes a creation phase 360, a localization phase 370, a query phase 380, and an entry phase 390.

Creation phase 361 involves creating database 320 at 361 using database editor 340. This includes the initial creation of database 320, but not the creation of a database program (e.g., Microsoft Access) used to create database 320. Creation phase 360 also includes modification to the structure of database 320, e.g., the addition or deletion of tables, fields, and vocabularies. In some cases, the creation phase can include the additions of records and database data, e.g., default data or data and records for a read-only database or portion of a database.

Localization phase 370 involves creating conversion tools 348 and pointers 339 using database editor 340 at 371. While localization phase 370 can be considered part of creation phase 360, herein, it is treated separately for emphasis and because creation phase 360 and localization phase 370 are often performed by different entities. In fact, if there are multiple localizations, each localization may be performed by a separate entity: e.g., the entity providing a French localization may be different than an entity providing a Chinese localization. In the case a localization tool is a table with columns corresponding to different localization, each column may be completed by a different entity.

Localization 371 also involves adding pointers to conversion tools 348 in association with fields 336. This may involve adding single pointers for each field for which localization is to be implemented. In that case, the conversion tool may provide for multiple localizations and forward and reverse conversions. In other examples, separate pointers can be associated with a field to specify locations of tools for different localizations and for different conversion directions (forward versus reverse). The pointers can be added in tables containing at least some of database data 332; alternatively, separate tables associating pointers with fields can be provided.

Query phase 380 involves receiving and responding to user queries. At 381, a user submits and user interface 342 receives a database query. As the query is generated, user interface 342 may present to the user with an interface to localization selector 344 and the user may have selected a localization. In that case, query handler 346 identifies the selected localization at 382. Alternatively, a localization may be automatically selected for a user, e.g., based on a user profile or the location from which the query is submitted. For example, a default Japanese localization may be applied if the query is made from a kiosk in Japan.

At 383, query handler 346 analyzes the query to determine the relevant fields for supplying database data for use in responding to the query. At 384, query handler 346 determines the relevant pointers for the determined localization and fields. If there are separate pointers for forward and reverse conversions, it is the pointer for the forward conversion that is sought here. At 385, query handler 346 identifies and obtains the conversion tools to be used in responding to the query from the locations specified by the pointers.

At 386, query handler 346 determines the relevant records 334 and native data 332 from the query. At 387, query handler 346 applies a forward conversion of the native data into data expressed in the localization identified at 382 to yield localized data 306. At 388, data presenter 349 presents localized data 306 in human-readable form, e.g., displays it on a display monitor or prints out a hard copy.

In some cases, a user will not only access data but modify or add data as well. For example, database 320 can be part of an airline reservation system. Query phase 380 may be used to identify available flights, while entry phase 390 can be used to input information required to identify the reservation holder as a reservation is made.

At 391, user interface 342 allows a user to enter localized data, e.g., into a form. In some cases, data entry can involve editing default or other data. In other cases, data may be entered into a blank field. At 392, user interface 242 applies conversion tools 348 to convert localized as-entered data into native data 332. At 393, database 320 is updated by storing the new native data therein.

A detail for system 300 is shown in FIG. 4. A database table 400 includes fields 336, e.g., fields F1-FM, pointers 339, e.g., pointers P1-PM, and records 334, e.g., records R1-RN. Database data 332, in the form of values V11-VNM, is arranged at the cell intersections of the fields 336 and records 334. Each pointer is designed to associate its respective field with a conversion tool. For example, pointer P1 associates field F1 with a conversion tool CT1. Pointer P2 associates field F2 with a conversion tool CT2. More than one pointer can point to a conversion tool; for example, pointers P1 and PM both associate their respective fields with conversion tool CT1.

Bidirectional conversion tools CT1 and CT2 are in the form of look-up translation tables that provide for both forward (native-to-localization) and reverse (localization-to-native) conversions. Conversion tool CT1 includes a native (in this case “English”) vocabulary VE1 and one or more localization vocabularies, in this case including an Afrikaans vocabulary VA1 and a Zulu vocabulary VZ1. Each vocabulary VE1, VA1, and VZ1 consists of the list of vocabulary existing or newly coined items (words or phrases) for those languages. As noted earlier, the vocabularies need not correspond to natural, national, or ethnic languages; for another example, there might be one localization for engineers and another localization for marketing.

Forward and reverse conversions are straight forward when there is a 1:1 correspondence in vocabulary items across vocabularies. If a localization vocabulary lacks a counterpart to a native vocabulary item, the native vocabulary item can be presented, e.g., in response to a query regardless of the localization associated with the query. System 300 does not permit localization vocabulary items without corresponding native vocabulary items. Another system can include provisions for handling such a case.

Conversion tool CT2 provides the same set of localization languages as conversion tool CT1. However, vocabularies VE2, VA2, and VZ2, differ from vocabularies VE1, VA1, and VZ1 to the extent to which the possible values for field F2 differ from the possible values for fields F1 and FM. In some instances, conversion tools can differ in the localizations they support even for the same database. For example, a conversion of American English to British English might only be used for those fields that accept entries that would be spelled differently in the two dialects.

A database 500, also implementable in database system 300, includes plural data tables TB1-TB3 and a pointer table TBP. Pointer table TBP includes all the fields F11-F33 from tables TB1-TB2 and associates each of them with a respective pointer P11-P33. As noted earlier, in some examples, a field can have separate pointers, e.g., for forward and reverse conversions and for different localizations.

Herein, a “system” is a set of interacting non-transitory tangible elements, wherein the elements can be, by way of example and not of limitation, mechanical components, electrical elements, atoms, physical encodings of instructions, and process segments. Herein, “process” refers to a sequence of actions resulting in or involving a physical transformation. “Storage medium” and “storage media” refer a system including non-transitory tangible material in or on which information is or can be encoded so as to be readable by a computer. “Computer-readable” refers to storage media in which information is encoded in computer-readable form. Data can also be stored or presented in “human-readable” form, which can include text and audio-visual elements.

Herein, “machine”, “device”, and “computer” refer to hardware or a combination of hardware and software. A “virtual” machine, device or computer is a software analog or representation of a machine, device, or server, respectively, and not a “real” machine, device, or computer. A “server” is a real (hardware or combination of hardware and software) or virtual computer that provides services to computers. Herein, unless otherwise apparent from context, a functionally defined component (e.g., database editor, user interface, localization selector, query handler, conversion tools, data presenter, etc.) of a computer is a combination of hardware and software executing on that hardware to provide the defined functionality. However, in the context of code encoded on computer-readable storage media, a functionally-defined component can refer to a physical encoding of software.

Herein, a computer is a machine having co-located or distributed components including computer-readable storage media, a processor, and one or more communications devices. The media stores or is configured to store code representing data including computer-executable instructions. The processor, which can include one or more central-processing units (CPUs), reads and manipulates data in accordance with the instructions. “Communication(s) device(s)” refers to computer-hosted devices used to transmit and/or receive data. Herein, a “computer network” is a network of communicatively coupled nodes, wherein the nodes can be, by way of example and not of limitation, servers, network infrastructure devices, and peripherals.

Herein, a “database” is a data structure designed for organizing, storing, and retrieving data. Typically, the data is organized into fields, i.e., data structures designed to hold data of a particular class. Some (but not all) databases include one or more tables. In such databases, table columns typically correspond to fields, while table rows correspond to records.

In this specification, related art is discussed for expository purposes. Related art labeled “prior art”, if any, is admitted prior art. Related art not labeled “prior art” is not admitted prior art. In the claims, “said” qualifies elements for which there is explicit antecedent basis in the claims; “the” refers to elements for which there is implicit antecedent basis in the claims; for example, the phrase “the center of said circle” indicates that the claims provide explicit antecedent basis for “circle”, which also provides as implicit antecedent basis for “center” since every circle contains exactly one center. The illustrated and other described embodiments, as well as modifications thereto and variations thereupon are within the scope of the following claims.

What is claimed is:

1. A process (200; 350) comprising:
using a computer (100; 302) to add (201; 361) fields (124; 336) to a database (110; 320); and
using said computer, specifying (202; 339) for each of said fields, a respective conversion tool (112; 348) for converting a native vocabulary (114; 337) for that field into a local vocabulary (116; 338) for that field so that first (F1) and second (F2) fields of said fields are associated with different conversion tools (CT1 and CT2).

2. A process as recited in claim 1 further comprising, in response to a query (381), using said conversion tool to convert (387) natively-expressed database data (332) into locally-expressed database data (306) and presenting (388) the locally-expressed database data to a user.

3. A process as recited in claim 1 further comprising:
using said conversion tool to convert (392) locally-expressed database data entered by a user to natively-expressed database data (332); and
storing (393) said natively-expressed database data in said database in at least one of said fields.

4. A process as recited in claim 1 wherein said conversion tool includes a look-up table (CT1).

5. A process as recited in claim 1 wherein said conversion tool includes a formula for converting a natively-expressed numerical value into a locally-expressed numerical value.

6. A system (100; 300) comprising:
plural conversion tools (112; 348) for converting a native vocabulary (114; 337) to local vocabularies (116; 338); and
a database (110; 320) having fields (124; 336) and pointers (126; 339) associating respective ones of said fields with respective sets of said conversion tools so that a first (CT1) of said conversion tools is associated (202) with a first (F1) of said fields but not with a second (F2) of said fields.

7. A system as recited in claim 6 further comprising a database editor (340) for adding (361) fields to said database and associating conversion tools with the added fields using pointers.

8. A system as recited in claim 6 further comprising:
a localization selector (344) for selecting a localization; and
a user interface (342) adapted to permit a user to interact with said selector to select a localization to be associated with a query submitted to said database.

9. A system as recited in claim 6 wherein at least one of said conversion tools is adapted for converting (392) locally expressed database data into natively expressed database data.

10. A system as recited in claim 1 wherein a least two pointers (P1 and PM) associate their different respective fields (F1 and FM) to the same conversion table (CT1) with which a third field (F2) is not associated.

11. A system (100; 300) comprising computer-readable storage media (106; 314) encoded with code (108; 316) configured to, when executed by a processor (102; 310):
add (201; 361) fields (124; 336) to a database (110; 320); and
specify (202; 371), for each of said fields, a respective conversion tool (202; 348) for converting a native vocabulary (114; 337) for that field into a local vocabulary (116; 338) for that field.

12. A system as recited in claim 11 further comprising said processor.

13. A system as recited in claim 11 wherein said code is further configured to, when executed by said processor, create (371) conversion tools for converting natively expressed database data (332) into locally expressed database data (306).

14. A system as recited in claim 13 wherein said code is further configured to, when executed by said processor, present (388) said locally expressed database data in human-readable form to a user.

15. A system as recited in claim 11 wherein said code is further configured to, when executed by said processor:
convert (392) locally expressed database data (336) into natively expressed database data (337); and
store said natively expressed database data, but not said locally expressed database data, in said database.
